(19) United States
(12) Patent Application Publication
(10) Pub. No.: US 2022/0099471 A1
(43) Pub. Date: Mar. 31, 2022

(54) LIQUID TRANSFER DEVICE

(71) Applicant: iCare Diagnostics International Co. Ltd., New Taipei City (TW)

(72) Inventors: SHUN-YAO CHENG, New Taipei (TW); JE-WEI CHIANG, New Taipei (TW); YU-SHENG CHANG, New Taipei (TW); YU-MIN WANG, New Taipei (TW); CHIA-HUA TSAI, New Taipei City (TW); CHUAN-CI HUANG, New Taipei City (TW)

(21) Appl. No.: 17/488,584

(22) Filed: Sep. 29, 2021

Related U.S. Application Data
(60) Provisional application No. 63/085,368, filed on Sep. 30, 2020.

(30) Foreign Application Priority Data
May 31, 2021 (CN) 202110604882.2

(51) Int. Cl. G01F 11/08; G01N 1/14

(52) U.S. Cl. CPC G01F 11/088; G01N 2001/1418; G01N 1/14

(57) ABSTRACT

A device for transferring liquids and liquid samples in certain quantities includes a first housing, a second housing, and a liquid extraction assembly. The first housing includes a first sidewall, a first top wall, an extrusion portion, and a first receiving cavity. The extrusion portion is disposed in the first receiving cavity. The second housing includes a second sidewall, a second top wall, and a second receiving cavity. The first housing is received in the second receiving cavity. The liquid extraction assembly includes a liquid extraction pipe and a liquid extraction head. By thumb or finger pressure, the first housing can be moved into the second receiving cavity to compress the extrusion portion to cause release of a sample, or released to gather a sample.

### FIELD

The subject matter relates to handling of samples, liquid transfer devices, and more particularly, to a liquid transfer device.

### BACKGROUND

Molecular diagnosis, morphological detection, and immunological detection are mostly carried out in laboratories. Detection processes are time-consuming, complex, inefficient, and inflexible, and detection devices are generally not portable. Transferring of a sample usually need to be done in a laboratory. Therefore, the detection cannot be carried out anytime and anywhere, especially at home.

### BRIEF DESCRIPTION OF THE DRAWINGS

Implementations of the present technology will now be described, by way of example only, with reference to the attached figures.

FIG. 1 is a diagrammatic view of an embodiment of a liquid transfer device in a resting state according to the present disclosure.

FIG. 2 is a diagrammatic view of the liquid transfer device when compressed according to the present disclosure.

FIG. 3 is an exploded diagrammatic view of the liquid transfer device according to the present disclosure.

FIG. 4 is a cross-sectional view taken along IV-IV of FIG. 1.

FIG. 5 is a cross-sectional view taken along V-V of FIG. 2.

FIG. 6 is a front, top perspective view of an embodiment of a first housing of the device according to the present disclosure.

FIG. 7 is a rear, bottom perspective view of the first housing according to the present disclosure.

FIG. 8 is a diagrammatic view of an embodiment of a second housing of the device according to the present disclosure.

FIG. 9 is a cross-sectional view of another embodiment of a liquid transfer device according to the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

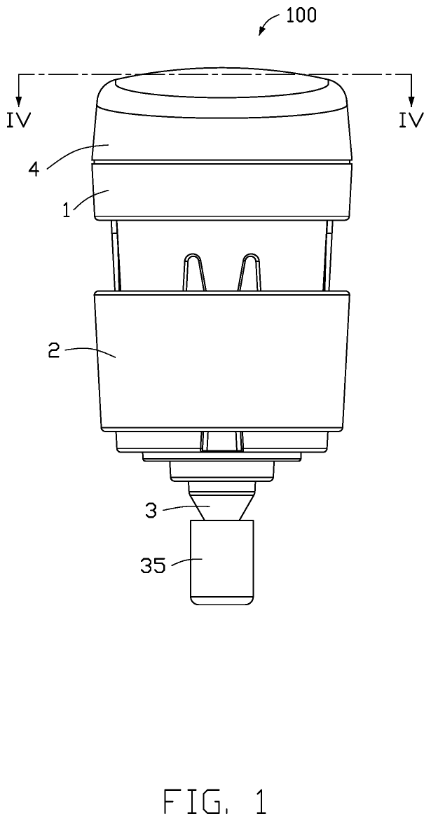

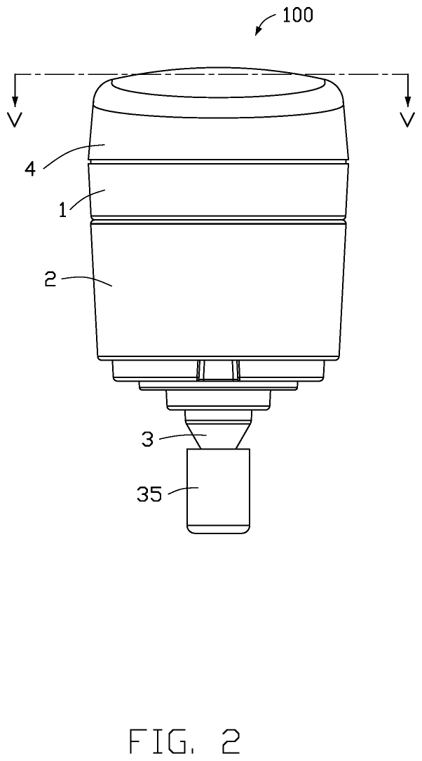

FIGS. 1 to 5 illustrate a liquid transfer device 100, which includes a first housing 1, a second housing 2, and a liquid extraction assembly 3. The first housing 1 includes a first sidewall 11, a first top wall 16, and an extrusion portion 12. The first sidewall 11 is connected to the first top wall 16. The first sidewall 11 and the first top wall 16 cooperatively define a first receiving cavity 13. The extrusion portion 12 is disposed on the first top wall 16 and received in the first receiving cavity 13. The second housing 2 includes a second sidewall 21 and a second top wall 24. The second sidewall 21 is connected to the second top wall 24. The second sidewall 21 and the second top wall 24 cooperatively define a second receiving cavity 22. The first housing 1 is received in the second receiving cavity 22 and can move back and forth along a central axis “C” of the second receiving cavity 22.

Referring to FIGS. 1 to 5, the liquid extraction assembly 3 includes a liquid extraction pipe 31 and a liquid extraction head 32 connected to the liquid extraction pipe 31. The liquid extraction pipe 31 is disposed between the first top wall 16 and the second top wall 24 and corresponds to the extrusion portion 12. The liquid extraction head 32 extends out of the second top wall 24. The extrusion portion 12 is used to apply pressure to the liquid extraction pipe 31. The first housing 1 can move back and forth along the central axis “C” of the second receiving cavity 22 to drive the extrusion portion 12 to move back and forth along the central axis “C” relative to the extraction pipe 31. Therefore, the liquid extraction pipe 31 is deformed for the release or the intake of liquid.

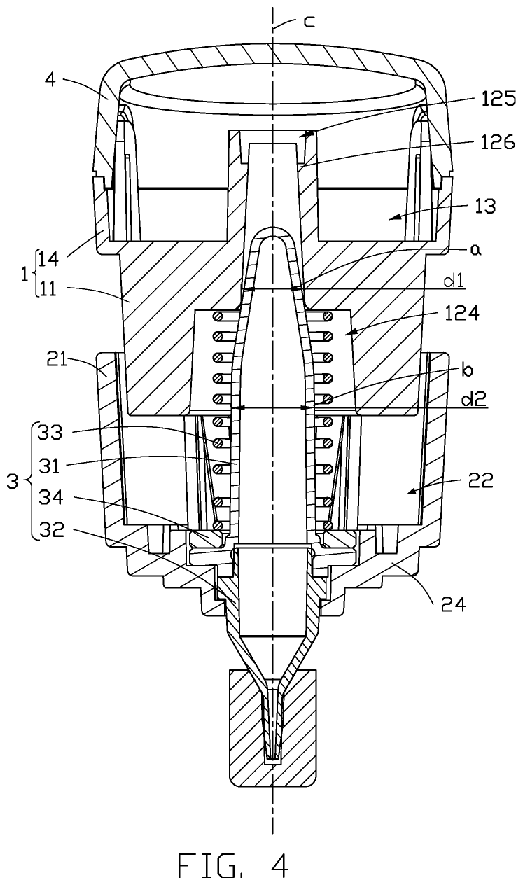

Referring to FIGS. 4 to 7, the extrusion portion 12 includes a third sidewall 121 and a fourth sidewall 122. One end of the third sidewall 121 is connected to the first top wall 16, and the other end is connected to the fourth sidewall 122. The third sidewall 121 defines a first through hole 124, and the fourth sidewall 122 defines a second through hole 125. The first through hole 124 is connected to the second through hole 125. The first through hole 124 and the second through hole 125 are both coaxial with the second receiving cavity 22. A diameter of the second through hole 125 is smaller than that of the first through hole 124, and the diameter of the second through hole 125 decreases in a direction away from the first through hole 124. The second receiving cavity 22 is connected to the first receiving cavity 13 through the first through hole 124 and the second through hole 125. The liquid extraction pipe 31 extends into or out of the second through hole 125 through the first through hole 124. The fourth sidewall 122 can compress or release a first sidewall of the liquid extraction pipe 31 to cause the liquid extraction pipe 31 to deform or regain its resting state, thereby allowing the liquid extraction pipe 31 to release or intake the liquid.

In an embodiment, at least one extrusion block 126 is disposed on a first inner surface of the fourth sidewall 122 close to the second through hole 125. The liquid extraction pipe 31 successively passes through the second receiving cavity 22 and the first through hole 124, and finally enters the second through hole 125. The extrusion block 126 compresses the liquid extraction pipe 31 to discharge out air or liquid inside the liquid extraction pipe 31. When the liquid extraction pipe 31 reversely exits from the second through hole 125, the liquid extraction pipe 31 rebounds to intake the liquid.

In an embodiment, two extrusion blocks 126 are disposed on the first inner surface of the fourth sidewall 122 and opposite to each other. The two extrusion blocks 126 can apply pressure to the liquid extraction pipe 31 from opposite sides to evenly deform the liquid extraction pipe 31. The amount/volume of liquid absorbed by the liquid extraction pipe 31 is associated with the degree of compression of the liquid extraction pipe 31. The degree of compression of the liquid extraction pipe 31 can be set by adjusting a distance between the two extrusion blocks 126.

In another embodiment, only one extrusion block 126 is included. The extrusion block 126 is annular and disposed on the first inner surface of the fourth sidewall 122.

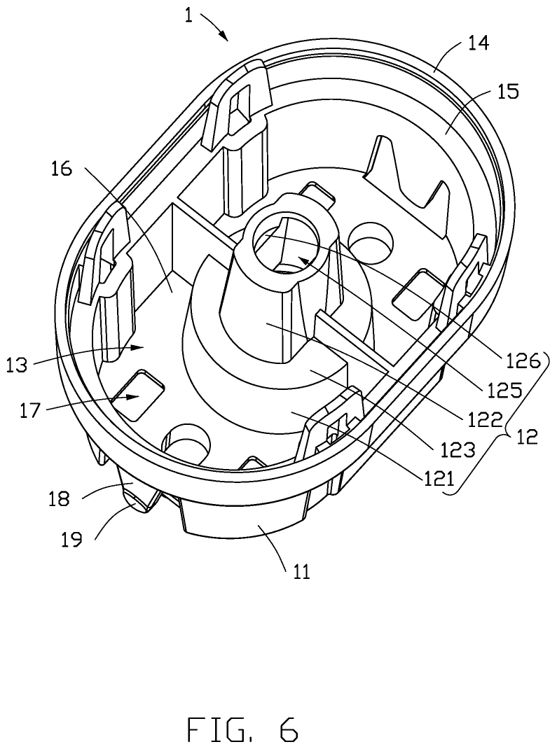

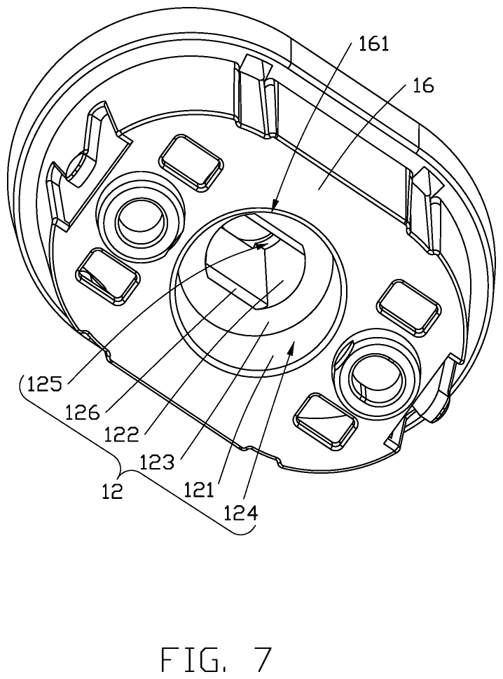

Referring to FIGS. 6 and 7, the first housing 1 further includes a fifth sidewall 14, a first platform portion 15, a first sliding rod 18, and a first hook 19. The fifth sidewall 14 is disposed on one end of the first sidewall 11 away from the first top wall 16. The first platform portion 15 is connected to the fifth sidewall 14 and the first sidewall 11. The first top wall 16 defines a positioning through hole 17. The first sliding rod 18 is disposed on the first sidewall 11. The first hook 19 is disposed on one end of the first sliding rod 18 away from the fifth sidewall 14. When the first housing 1 moves back and forth along the central axis “C” of the second receiving cavity 22 relative to the second housing 2, an end of the second sidewall 21 is supported on a surface of the first platform portion 15 close to the first sidewall 11. The first platform portion 15 limits a moving distance of the second sidewall 21. The first top wall 16 defines a third through hole 161 corresponding to the first through hole 124. The third through hole 161 and the first through hole 124 are both coaxial with the second through hole 125. A diameter of the third through hole 161 is equal to that of the first through hole 124.

In an embodiment, there are two first sliding rods 18 disposed on opposite sides of the first sidewall 11.

In another embodiment, four positioning through holes 17 are disposed on the first top wall 16.

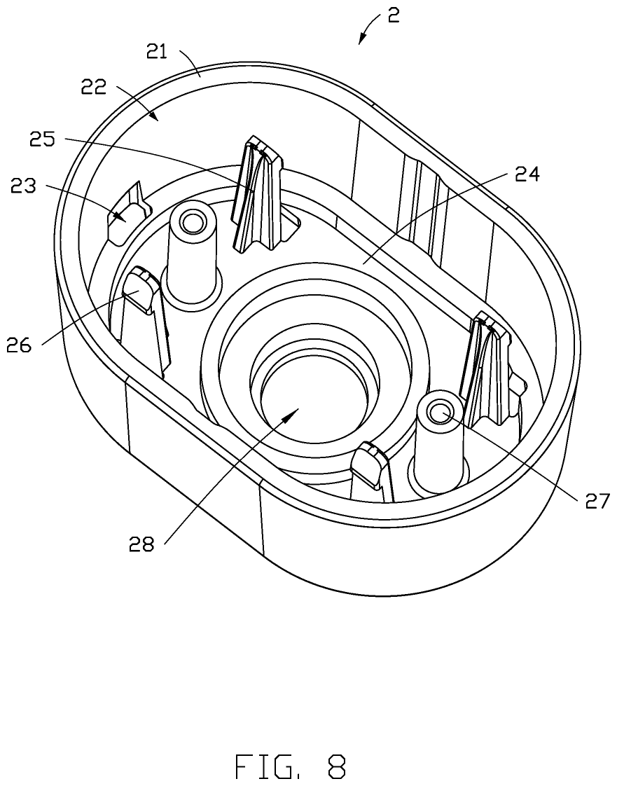

Referring to FIGS. 4 to 8, the second housing 2 further includes a second sliding rod 25, a second hook 26, and a first guiding post 27. The second sidewall 21 defines a sliding slot 23. The second top wall 24 defines a fourth through hole 28 corresponding to the third through hole 161. The second sliding rod 25 is disposed on a side of the second top wall 24 close to the second receiving cavity 22. The second hook 26 is disposed on an end of the second sliding rod 25 close to the first top wall 16. The first guiding post 27 is disposed on a side of the second top wall 24 close to the second receiving cavity 22. The fourth through hole 28 is coaxial with the third through hole 161. A diameter of the fourth through hole 28 is equal to that of the third through hole 161. The first sliding rod 18 can move up and down relative to the sliding slot 23. The first hook 19 snaps into the sliding slot 23 and moves in the sliding slot 23 when driven by the first sliding rod 18, to realize a movable clamping connection between the first sidewall 11 and the second sidewall 21. The first top wall 16 faces the second top wall 24. The second sliding rod 25 passes through the positioning through hole 17 on the first top wall 16, and moves up and down relative to the positioning through hole 17. The second hook 26 can clamp on an inner surface of the first top wall 16 corresponding to the positioning through hole 17 to prevent the first housing 1 and the second housing 2 from separating from each other during the movement. The first guiding post 27 can pass through a guide hole (not shown) on the first top wall 16 to guide the relative movement of the first housing 1 and the second housing 2. In addition, a positioning head (not shown), such as a screw (not shown), is detachably disposed on an end of the first guiding post 27 close to the first top wall 16, which screws into the first guiding post 27. Thus, the first guiding post 27 can be prevented from falling out of the guide hole, acquiring a stable connection between the first housing 1 and the second housing 2.

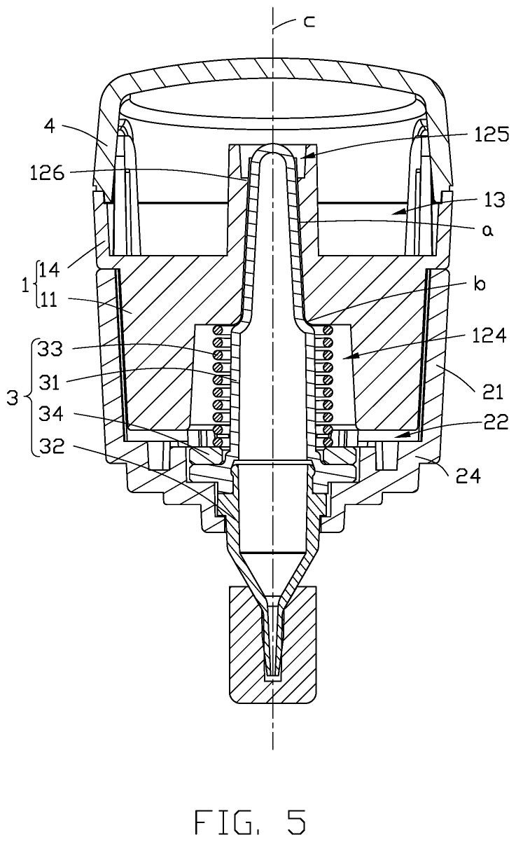

Referring to FIGS. 4 and 5, the liquid extraction pipe 31 is substantially a hollow tube with an open end. A cross section along a direction perpendicular to the central axis “C” is substantially circular. The liquid extraction head 32 is substantially a hollow tube with an opening at both ends. One end of the liquid extraction head 32 is connected to the open end of the liquid extraction pipe 31. An end of the liquid extraction pipe 31 away from the liquid extraction head 32 is configured to move back and forth along the central axis “C” in the second through hole 125. An end of the liquid extraction head 32 away from the liquid extraction pipe 31 extends out of the second housing 2 through the fourth through hole 28.

In an embodiment, the liquid extraction pipe 31 may be made of rubber. An area of the cross section of the liquid extraction pipe 31 perpendicular to the central axis “C” gradually decreases from one end close to the liquid extraction head 32 to the other end away from the liquid extraction head 32. Thus, the liquid extraction pipe 31 is substantially an inverted conical pipe.

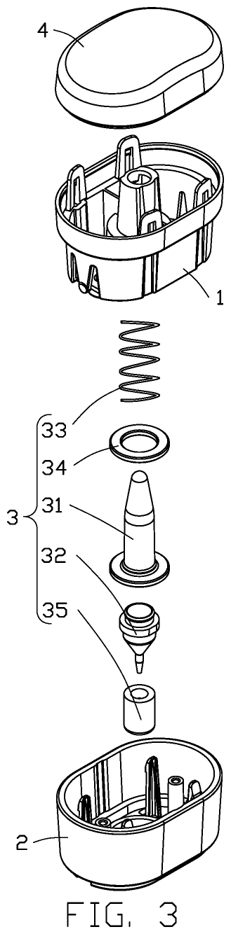

Referring to FIGS. 3 to 5, the liquid extraction assembly 3 further includes an elastic member 33 and a washer 34. The elastic member 33 and the washer 34 are sleeved on the liquid extraction pipe 31. One end of the elastic member 33 is connected to the extrusion portion 12, and the other end is connected to the second top wall 24. When the first housing 1 moves down along the central axis “C” relative to the second housing 2, the elastic member 33 is compressed and deformed. When first housing 1 moves up along the central axis “C” relative to the second housing 2, the elastic member 33 rebounds and drives the first housing 1 to return to its original position. The washer 34 is sleeved on the liquid extraction pipe 31 corresponding to the fourth through hole 28 to fix and seal the liquid extraction assembly 3.

In an embodiment, for fixing the elastic member 33, the extrusion portion 12 further includes a second platform portion 123. One end of the second platform portion 123 is connected to an end of the third sidewall 121 away from the first top wall 16, and the other end is connected to an end of the fourth sidewall 122 close to the first top wall 16. One end of the elastic member 33 is connected to the second platform portion 123 and the other end is connected to the second top wall 24.

Referring to FIGS. 1 to 3, the liquid extraction assembly 3 further includes a head cover 35, which can cover an end of the liquid extraction head 32 away from the liquid extraction pipe 31 to prevent pollution of the liquid extraction head 32.

Referring to FIGS. 3 to 5, an assembly process of the liquid transfer device 100 includes following steps. At step one, the liquid extraction assembly 3 passes through the fourth through hole 28 from the second receiving cavity 22 of the second housing 2. At step two, the washer 34 is set on a side of the liquid extraction assembly 3 close to the second receiving cavity 22, to realize the connection between the liquid extraction assembly 3 and the second housing 2. At step three, the first housing 1 and the second housing 2 are assembled together. The liquid extraction assembly 3 is installed inside the first housing 1 and the second housing 2.

Referring to FIG. 4, the liquid transfer device 100 further includes a pressing key 4, which covers one end of the fifth sidewall 14 of the first housing 1 away from the first sidewall 11. By pressing the pressing key 4, the first housing 1 can move relative to the second housing 2.

Referring to FIGS. 4 and 5, a portion of the liquid extraction pipe 31 away from the liquid extraction head 32 has a small inner diameter “D₁”, such portion being referred to as smaller end “a”. Another portion of the liquid extraction pipe 31 close to the liquid extraction head 32 has a large inner diameter “D₂”, such portion being referred to as larger end “b”. Referring to FIG. 4, before the liquid extraction pipe 31 is compressed, the smaller end “a” is located at the bottom of the two extrusion blocks 126, and surfaces of the two extrusion blocks 126 are connected to a top of the liquid extraction pipe 31. Referring to FIG. 5, when the first housing 1 moves down, the liquid extraction pipe 31 extends out of an opening of the two extrusion blocks 126 away from the liquid extraction head 32, so that the liquid extraction pipe 31 is compressed by the extrusion blocks 126. Finally, the smaller end “a” of the liquid extraction pipe 31 extends into a top of the second through hole 125, the larger end “b” is located at the bottom of the two extrusion blocks 126, and the two extrusion blocks 126 squeeze and compress a sidewall of the liquid extraction pipe 31 to discharge all or some of contents of the liquid extraction pipe 31. When the liquid extraction head 32 is immersed into a liquid, the first housing 1 can be released, and the elastic member 33 rebounds and drives the first housing 1 back to its original position, so that the liquid extraction pipe 31 exits from the two extrusion blocks 126, and the liquid extraction pipe 31 rebounds to absorb liquid. The compression degree of the liquid extraction pipe 31 can be controlled to control the volume of the absorbed liquid, so as to achieve certain quantities of liquid extraction. The compression degree of the liquid extraction pipe 31 can be controlled by designing the inner diameter “D₁” and the inner diameter “D₂” of the liquid extraction pipe 31, a distance between the two extrusion blocks 126, the contact area between the two extrusion blocks 126 and the liquid extraction pipe 31, and a distance of movement stroke of the first housing 1 relative to the second housing 2.

When in use, the first housing 1 can be pressed to move down along a sidewall of the second housing 2 to compress the liquid extraction pipe 31. Thus, air inside the liquid extraction pipe 31 is pushed out, causing the liquid extraction head 3 to receive the liquid. After receiving the liquid, the liquid extraction pipe 31 pushes the first housing 1 to return to its original position. When the liquid in the liquid extraction pipe 31 needs to be discharged out, the first housing 1 can be pressed again to move down relative to the second housing 2, which completes the discharge of liquid from the liquid extraction pipe 31.

The liquid transfer device 100 provided by the present disclosure can be used to transfer a variety of liquids. For example, samples of the liquid may be, but are not limited to, a biological sample, a veterinary sample, or an environmental sample.

The liquid transfer device 100 provided by the present disclosure can be used to collect and prepare volumes of 1 μl˜5 ml (such as 1 μl, 2 μl, 4 μl, 5 μl, 10 μl, 20 μl, 50 μl, 100 μl, 200 μl, 500 μl, 1 ml, 2 ml, and 5 ml of liquid, and volumes in between).

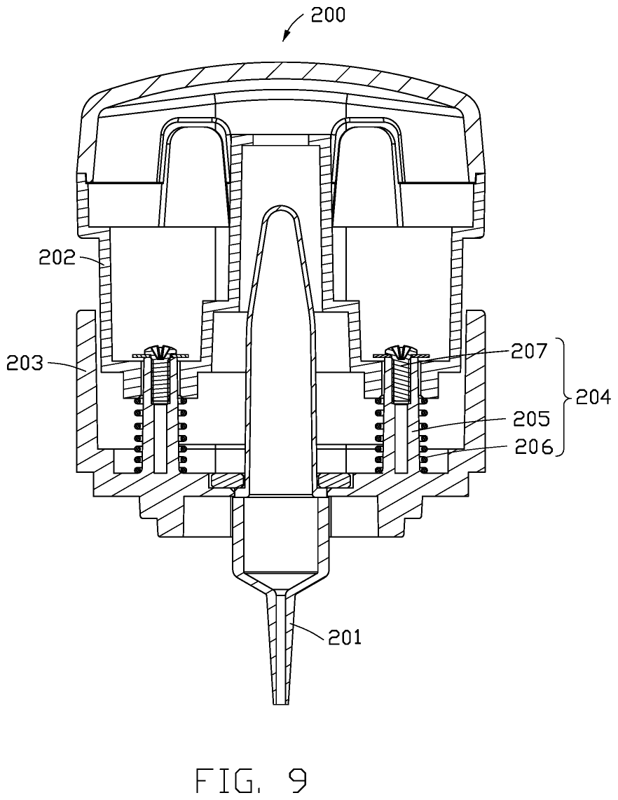

FIG. 9 illustrates another liquid transfer device 200. Differences between the liquid transfer device 200 and the liquid transfer device 100 are that the liquid transfer device 200 further includes a plurality of elastic assemblies 204 disposed around the liquid extraction assembly 201. Each elastic assembly 204 includes a second guiding post 205 disposed on a side of the second top wall 24 close to the second receiving cavity 22, a return spring 206 sleeved on the second guiding post 205, and a stop member 207 disposed on an end of the second guiding post 205 away from the second top wall 24. The second guiding post 205 penetrates the first top wall 16, and the stop member 207 is located in the first receiving cavity 13. One end of the return spring 206 is connected to the first top wall 16 and the other end is connected to the second top wall 24. The return spring 206 can move the first housing 202 away from the second housing 203. The features of the liquid transfer device 100 can be applicable to the liquid transfer device 200. The elastic assemblies 204 around the liquid extraction assembly 201 can facilitate an installation of the liquid extraction assembly 201. The elastic assemblies 204 render the forces on the first housing 202 more uniform and provide a stable rebounding process of the first housing 202.

The liquid transfer device 100 has the advantages of simple overall structure, low cost, and convenient operation.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including, the full extent established by the broad general meaning of the terms used in the claims.

What is claimed is:

1. A liquid transfer device, comprising:
a first housing;
a second housing; and
a liquid extraction assembly;
wherein the first housing comprises a first sidewall, a first top wall, and an extrusion portion, the first sidewall is connected to the first top wall, the first sidewall and the first top wall cooperatively define a first receiving cavity, the extrusion portion is disposed on the first top wall and received in the first receiving cavity, the second housing comprises a second sidewall and a second top wall, the second sidewall is connected to the second top wall, the second sidewall and the second top wall cooperatively define a second receiving cavity, the first housing is received in the second receiving cavity;
wherein the liquid extraction assembly comprises a liquid extraction pipe and a liquid extraction head connected to the liquid extraction pipe, the liquid extraction pipe is disposed between the first top wall and the second top wall and corresponds to the extrusion portion, the liquid extraction head extends out of the second top wall, the extrusion portion is configured to squeeze the liquid extraction pipe, the first housing is configured to move back and forth along a central axis of the second receiving cavity to drive the extrusion portion to move back and forth along the central axis relative to the extraction pipe, thereby causing the liquid extraction pipe to be compressed and rebounded to release or intake liquid.

2. The liquid transfer device of claim 1, wherein the extrusion portion comprises a third sidewall and a fourth sidewall, one end of the third sidewall is connected to the first top wall, and the other end of the third sidewall is connected to the fourth sidewall, the third sidewall defines a first through hole, the fourth sidewall defines a second through hole, the first through hole is connected to the second through hole, the first through hole and the second through hole are both coaxial with the second receiving cavity, the first receiving cavity is connected to the second receiving cavity through the first through hole and the second through hole.

3. The liquid transfer device of claim 2, wherein a diameter of the second through hole is smaller than a diameter of the first through hole, the diameter of the second through hole decreases in a direction away from the first through hole, the liquid extraction pipe is configured to extend into or exit out of the second through hole through the first through hole, the fourth sidewall is configured to squeeze or release the liquid extraction pipe.

4. The liquid transfer device of claim 3, wherein at least one extrusion block is disposed on an inner surface of the fourth sidewall close to the second through hole, and the at least one extrusion block is configured to squeeze or release the liquid extraction pipe.

5. The liquid transfer device of claim 4, wherein two extrusion blocks are disposed on the inner surface of the fourth sidewall and opposite to each other.

6. The liquid transfer device of claim 4, wherein the extrusion block is annular and disposed on the inner surface of the fourth sidewall.

7. The liquid transfer device of claim 1, wherein the first housing further comprises a first sliding rod and a first hook, the first sliding rod is disposed on the first sidewall, the first hook is disposed on an end of the first sliding rod close to the liquid extraction head, the first top wall defines a third through hole, the second receiving cavity is connected to the first receiving cavity through the third through hole, the liquid extraction pipe is configured to pass through the third through hole to connect to the extrusion portion.

8. The liquid transfer device of claim 7, wherein the second housing further comprises a second sliding rod, and a second hook, the second sidewall defines a sliding slot, the second top wall defines a fourth through hole corresponding to the third through hole, the second sliding rod is disposed on a side of the second top wall close to the second receiving cavity, the second hook is disposed on an end of the second sliding rod close to the first top wall,
the first top wall faces the second top wall, the fourth through hole is coaxial with the third through hole, the first sliding rod is configured to move up and down relative to the sliding slot, the first hook is configured to snap into the sliding slot and move in the sliding slot when driven by the first sliding rod, the second sliding rod is configured to pass through the first top wall and move up and down along the central axis of the second receiving cavity, the second hook is disposed to clamp on a surface of the first top wall close to the second receiving cavity.

9. The liquid transfer device of claim 8, wherein the second housing further comprises a first guiding post, the first guiding post is disposed to pass through the first top wall to guide a relative movement of the first housing and the second housing.

10. The liquid transfer device of claim 8, wherein a diameter of the fourth through hole is equal to a diameter of the third through hole.

11. The liquid transfer device of claim 1, wherein the first housing further comprises a fifth sidewall and a first platform portion, the fifth sidewall is disposed on one end of the first sidewall away from the first top wall, the first platform portion is connected to the fifth sidewall and the first sidewall, an end of the second sidewall close to the fifth sidewall is connected to a surface of the first platform portion.

12. The liquid transfer device of claim 1, further comprising an elastic member, wherein the elastic member is sleeved on the liquid extraction pipe, one end of the elastic member is connected to the extrusion portion, and the other end of the elastic member is connected to the second top wall, the elastic member is configured to drive the first housing to move away from the liquid extrusion head.

13. The liquid transfer device of claim 12, wherein the extrusion portion further comprises a second platform portion, and the second platform portion is configured to fix the elastic member.

14. The liquid transfer device of claim 1, further comprising a washer sleeved on the liquid extraction pipe.

15. The liquid transfer device of claim 1, further comprises a plurality of elastic assemblies, wherein each of the plurality of elastic assemblies is disposed around the liquid extraction assembly, each of the plurality of elastic assemblies comprises a second guiding post disposed on a side of the second top wall close to the second receiving cavity, a return spring sleeved on the second guiding post, and a stop member disposed on an end of the second guiding post away from the second top wall, the second guiding post penetrates the first top wall, and the stop member is located in the first receiving cavity, one end of the return spring is connected to the first top wall and the other end is connected to the second top wall, the return spring is configured to drive the first housing to move away from the second housing.

16. The liquid transfer device of claim 1, wherein an area of a cross section of the liquid extraction pipe perpendicular to the central axis decreases from one end close to the liquid extraction head to another end away from the liquid extraction head.

17. The liquid transfer device of claim 1, wherein the liquid extraction assembly further comprises a head cover, the head cover covers on an end of the liquid extraction head away from the liquid extraction pipe.

18. The liquid transfer device of claim 1, further comprising a pressing key disposed on one end of the first housing away from the liquid extraction head.
